(19) United States
(12) Patent Application Publication
(10) Pub. No.: US 2023/0070001 A1
(43) Pub. Date: Mar. 9, 2023

(54) MULTI-LAYER SLIP FILM

(71) Applicant: Malpack Ltd., Ajax (CA)

(72) Inventors: Ramin Bolourian, Stouffville (CA); Istuffer Sanchez, Scarborough (CA)

(73) Assignee: Malpack Ltd., Ajax (CA)

(21) Appl. No.: 17/902,444

(22) Filed: Sep. 2, 2022

Related U.S. Application Data
(60) Provisional application No. 63/240,407, filed on Sep. 3, 2021.

(51) Int. Cl. B32B 27/08; B32B 27/32

(52) U.S. Cl. CPC B32B 27/08; B32B 27/32; B32B 2250/242; B32B 2274/00; B32B 2270/00; B32B 2307/744; B32B 2307/746; B32B 2553/00

(57) ABSTRACT

Embodiments of the present invention include a multilayer cling film comprising a first skin layer comprising a blend of a polyethylene and an ionomer, a second skin layer comprising a blend of a polyethylene and a polyolefin-based thermoplastic elastomer and one or more core layers comprising a polyethylene, a blend of two or more polyethylenes, or a combination thereof.

### CROSS REFERENCE TO RELATED APPLICATION

This application claims the priority of the provisional application Ser. No. 63/240,407 filed Sep. 3, 2021. Applicant hereby incorporates by reference the entire content of provisional application Ser. No. 63/240,407.

### FIELD OF INVENTION

The present invention is related to multi-layer slip films which include at least four layers. More specifically, the present invention relates to multi-layer slip films which include four or more layers with reduced coefficient of friction between two or more layers and enhanced cling properties resulting in superior pallet wrapping performance.

### BACKGROUND OF THE INVENTION

The use of thermoplastic stretch wrap films for the overwrap packaging of goods, and more specifically, securing and stabilizing palleted loads for easy transport is a commercially significant application of polymer film. Overwrapping a variety of goods to provide a secure and stable load can be achieved by a variety of techniques. In one procedure, the goods are positioned upon a rotating platform, or turntable to take up stretch wrap film supplied from a continuous roll. Braking tension is applied to the film roll so that the film is continuously subjected to a stretching, or tensioning, force as it wraps around the rotating load in overlapping layers. Generally, the stretch wrap film is supplied from a vertically arranged roll positioned adjacent to the rotating pallet load. At the completion of the overwrap operation, the turntable is stopped and the film is cut and attached to an underlying layer of film. Depending upon the width of the stretch wrap roll, the load being overwrapped can be secured by the film while the vertically arranged film roll remains in a fixed position. Alternatively, the film roll, for example, in the case of relatively narrow film widths and relatively wide pallet loads, can be made to move in a vertical direction as the load is being overwrapped whereby a spiral wrapping effect is achieved on the packaged goods.

Hand wrapping is another wrapping method common for palletization. In this method, the film roll is dispensed by hand by an operator who walks around the goods to be wrapped, applying the film to the goods as needed. The roll of film so used may be installed on a hand-held wrapping tool for ease of use by the operator.

Stretch wrap film is designed to incorporate a variety of desirable properties such as good cling or cohesion properties, high puncture resistance, high stress retention, good transparency, low haze, low or high degree of slip, low stress relaxation with time, high tear resistance in the transverse direction, good machine direction tear resistance, high resistance to transverse tear when under machine direction tension, producible in thin gauges, low specific gravity and thus high yield in area per pound, good tensile toughness, high machine direction ultimate tensile strength, high machine direction ultimate elongation, and low modulus of elasticity.

Monolayer stretch wrap films have identical surfaces on both sides, while multilayer stretch films can have a cling surface and a non-cling surface. The non-cling surface is designed to not cling to itself and prevents adjoining wrapped goods from sticking to one another. The cling surface enables the film to stick to itself and even to the palletized goods to prevent unwrapping during transport. However, as the non-cling surface decreases in coefficient of friction, the cling surface must increase its cling aggressiveness to enable the film to stick to itself when wrapped around goods.

Thus, there is a need for an improved slip-cling stretch film and a method for its production having both a high slip surface and an aggressive cling surface.

### SUMMARY OF THE INVENTION

Embodiments of the present invention include a multilayer cling film comprising a first skin layer comprising a blend of a polyethylene and an ionomer, a second skin layer comprising a blend of a polyethylene and a polyolefin-based thermoplastic elastomer and one or more core layers comprising a polyethylene, a blend of two or more polyethylenes, or a combination thereof.

### DESCRIPTION OF THE DRAWINGS

To facilitate the understanding of the features of the present invention, a more particular description of embodiments of the present invention, briefly summarized above, may be had by reference to an embodiment, which is illustrated in the attached drawings. It is to be noted, however, the attached drawings illustrate only a typical embodiment of embodiments encompassed within the scope of the present invention, and, therefore, is not to be considered limiting, for the present invention may admit to other equally effective embodiments.

FIG. 1 illustrates a cross-sectional view of a stretch film in accordance with one embodiment of the instant invention.

FIG. 2 illustrates a cross-sectional view of a stretch film in accordance with one embodiment of the instant invention.

### DETAILED DESCRIPTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

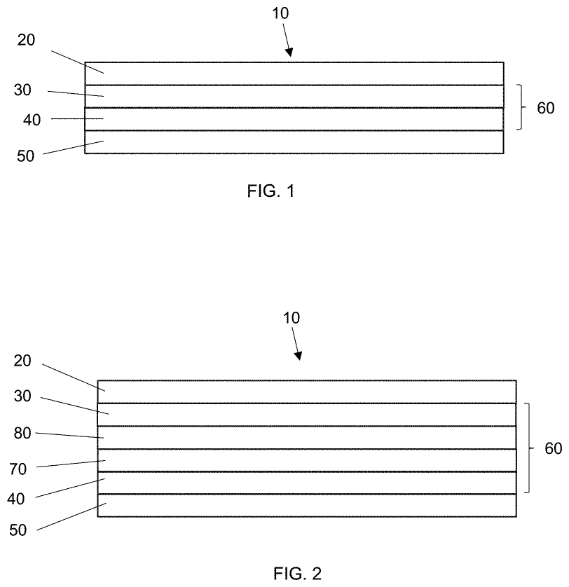

The instant invention discloses a multilayer cling film comprising a first skin layer comprising a blend of a polyethylene and an ionomer, a second skin layer comprising a blend of a polyethylene and a polyolefin-based thermoplastic elastomer and one or more core layers comprising a polyethylene, a blend of two or more polyethylenes, or a combination thereof. Looking now to the Figures, FIG. 1 illustrates a cross-sectional view of a film in accordance with one embodiment of the instant invention. The film 10 generally comprises a first skin layer 20, a second skin layer 50, and a central layer 60 which is comprised of one or more core layers located between the skin layers 20 and 50. In the embodiment illustrated in FIG. 1, the central layer 60 includes a first core layer 30 and a second core layer 40. Each skin layer 20, 50 comprises between about 5% by weight and about 20% by weight of the film 10, between about 7% by weight and about 12% by weight of the film 10, between about 10% by weight and about 15% by weight of the film 10, or between about 10% by weight and about 20% by weight of the film 10. Each core layer 30, 40 comprises between about 30% by weight and about 45% by weight of the film 10, between about 32% by weight and about 42% by weight of the film 10, between about 35% by weight and about 40% by weight of the film 10, or between about 30% by weight and about 40% by weight of the film 10.

The first skin layer 20 can be a slip layer comprising a polymer composition yielding a low coefficient of friction (COF) per the ASTM D1894. The COF of the first skin layer is at least less than 1.1, between about 0.1 and 1.1, between about 0.3 and 0.9, between about 0.5 and 0.9, between about 0.1 and 0.5, or between 0.6 and 0.9. The COF of the first skin layer is at least less than 1.1, 1.0, 0.9, 0.8, 0.7, 0.6, 0.5, or 0.4. The first skin layer 20 can be a slip layer comprising a linear low-density polyethylene (LLDPE), a high-density polyethylene (HDPE) and an ionomer of ethylene acid copolymer/an ionomer of ethylene acid acrylate terpolymer composition. The LLDPE is provided in a range of about 75% by weight to about 99% by weight, the HDPE is provided in a range of about 1% by weight to about 25% by weight and balance of the composition comprises the ionomer of ethylene acid copolymer/an ionomer of ethylene acid acrylate terpolymer. In one embodiment the LLDPE is provided in a range of about 80% by weight to about 95% by weight, the HDPE is provided in a range of about 4% by weight to about 20% by weight and the balance of the composition comprises the ionomer of ethylene acid copolymer/an ionomer of ethylene acid acrylate terpolymer, generally in a range of about 1% by weight to about 15% by weight. In another embodiment, the LLDPE is provided in a range of about 80% by weight to about 95% by weight, the HDPE is provided in a range of about 4% by weight to about 20% by weight and the ionomer of ethylene acid copolymer/an ionomer of ethylene acid acrylate terpolymer is provided in a range of about 1% by weight to about 15% by weight, and the balance of the composition comprises at least one resin or additive, such as stabilizers, UV absorbers, colorants, abrasion-resistant resins, and the like.

The LLDPE is a linear low-density polyethylene plastic material commercially available from ExxonMobile, United States of America, under the brand name ExxonMobil LLDPE LL 1236 Series. The LLDPE has a density of about 0.925 g/cm³, and a melt index of about 3.6 g/10 min according to ASTM test methods D1505 and D1238, respectively. The LLDPE can be a linear low-density polyethylene plastic material commercially available from Dupont-Dow, United States of America, under the brand name DOWLEX 2045G. The LLDPE has a density of about 0.920 g/cm³, and a melt index of about 1.0 g/10 min according to ASTM test methods D792 and D1238, respectively.

The HDPE is a high-density plastic material commercially available from ExxonMobile, United States of America, under the brand name ExxonMobil HDPE 7845.30. The HDPE has a density of about 0.958 g/cm³, and a melt index of about 0.45 g/10 min and a high load melt index of about 28 g/10 min according to ASTM test methods D1505, D1238 and D1238, respectively.

The ionomer of ethylene acid copolymer/an ionomer of ethylene acid acrylate terpolymer is commercially available from Dupont-Dow, United States of America, under the brand name(s) Surlyn 1652, Surlyn 1605, and Surlyn 1901. The ionomer of ethylene acid copolymer (Surlyn 1652) has a density of 0.94 g/cm³, and a melt flow rate of 5.2 g/10 min according to ASTM test methods D792 and D1238, respectively. The ionomer of ethylene acid acrylate terpolymer (Surlyn 1605) has a density of 0.95 g/cm³, and a melt flow rate of 2.5 g/10 min according to ASTM test methods D792 and D1238, respectively. The ionomer of ethylene acid acrylate terpolymer (Surlyn 1901) has a density of 0.94 g/cm³, and a melt flow rate of 1.3 g/10 min according to ASTM test methods D792 and D1238, respectively. In yet another embodiment, a resin can be a substitute for the ionomer of ethylene acid copolymer/an ionomer of ethylene acid acrylate terpolymer. The resin is a PE LDPE with a higher density and melt flow rate. The substitute will have a density range of approximately 0.92-0.94 g/cm³ and a high melt flow rate range of approximately 3.0-6.5 g/10 min. The substitutes are commercially available from Dupont-Dow, United States of America, under the brand name(s) DOW 5004i LDPE (0.924 g/cm³, 4.2 g/10 min) and DOW 751A LDPE (0.925 g/cm³, 6.4 g/10 min).

The second skin layer 50 can be a cling layer comprising a polymer composition yielding a high cling. The force of the second skin layer 50 (cling layer) to the first skin layer 20 (slip layer), when wrapped around one or more items, is a least 20, generally at least about 30, preferably at least about 40 and more preferably about 50 N/mm² as determined by the ASTM D5458-95 test. The second skin layer 50 can be a cling layer comprising an ultra-low-density polyethylene (ULDPE) and a polyolefin-based thermoplastic such as a propylene-based polyolefin polymer or a polypropylene-based elastomer with random ethylene distribution. The ULDPE is provided in a range of about 80% by weight to about 99% by weight, and the balance of the composition comprises a polyolefin-based thermoplastic. In one embodiment the ULDPE is provided in a range of about 82% by weight to about 97% by weight, and the balance of the composition comprises a polyolefin-based thermoplastic. In another embodiment the ULDPE is provided in a range of about 85% by weight to about 96% by weight, and the balance of the composition comprises a polyolefin-based thermoplastic. In another embodiment, the ULDPE is provided in a range of about 85% by weight to about 96% by weight, the polyolefin-based thermoplastic is provided in a range of about 4% by weight to about 15% by weight, and the balance of the composition comprises at least one resin or additive, such as stabilizers, UV absorbers, colorants, abrasion-resistant resins, and the like. The second skin layer 50 may further comprises additional resins and additives. In one embodiment, the second skin layer 50 comprises a puncture resistant resin. The optional cling additives may be present in the second skin layer 50 in a concentration of from about 0.5% by weight to about 10% by weight of the second skin layer 50 composition.

The ULDPE is an ultra-low-density polyethylene plastic material commercially available from Dow Chemical Company, United States of America, under the brand name ATTANE 4404G. The ULDPE has a density of about 0.906 g/cm³, and a melt flow rate of about 1.4 g/10 min according to ASTM test methods D792 and D1238, respectively.

The polyolefin-based thermoplastic is a propylene-based polyolefin polymer or a polypropylene-based elastomer with random ethylene distribution material from ExxonMobile, United States of America, under the brand name Vistamaxx Performance Polymer 6102. The propylene-based polyolefin polymer or a polypropylene-based elastomer with random ethylene distribution has a density of about 0.862 g/cm³, and a melt flow rate of about 3.0 g/10 min according to ASTM test methods D1505 and D1238, respectively. In another embodiment, a resin can be a substitute for the polyolefin-based thermoplastic. The resin is a polyolefin plastomer commercially available from Dupont-Dow, United States of America, under the brand name DOW Affinity KC 8852G (0.877 g/cm³, 3.0 g/10 min).

The central layer 60 includes at least one or more layers of polymeric compositions producing necessary mechanical properties of the film, such as extensibility, load containment, tear, resistance, puncture resistance, and the like. Looking again to FIG. 1, there is illustrated a central layer 60 which includes a first core layer 30 and a second core layer 40. In one embodiment, the first core layer 30 is a linear low-density polyethylene and the second core layer 40 is a blend of linear low-density polyethylene and low-density polyethylene. In another embodiment, the first core layer 30 is a metallocene linear low-density polyethylene (m-LLDPE) and the second core layer 40 is a blend of metallocene linear low-density polyethylene (m-LLDPE) and low-density polyethylene (LDPE). In still another embodiment, the first core layer 30 is a metallocene linear low-density polyethylene (m-LLDPE) and the second core layer 40 is a blend of linear low-density polyethylene (LLDPE) and low-density polyethylene (LDPE).

The first core layer 30 can be a linear low-density polyethylene provided at 100% by weight. The first core layer 30 can be a metallocene linear low-density polyethylene (m-LLDPE). In one embodiment, the m-LLDPE is a metallocene linear low-density polyethylene material available from Dow Chemical Company, United States of America, under the brand name Elite 5230G or Elite 5230S. The metallocene linear low-density polyethylene (5230G) has a density of about 0.918 g/cm³, and a melt flow rate of about 4.0 g/10 min according to ASTM test methods D792 and D1238, respectively. The metallocene linear low-density polyethylene (5230S) has a density of about 0.916 g/cm³, and a melt flow rate of about 4.0 g/10 min according to ASTM test methods D792 and D1238, respectively.

The second core layer 40 can be a blend of metallocene linear low-density polyethylene (m-LLDPE) provided in a range of about 25% by weight to about 65% by weight and low-density polyethylene (LDPE) provided in a range of about 35% by weight to about 75% by weight. The second core layer 40 can be a blend of metallocene linear low-density polyethylene (m-LLDPE) provided in a range of about 30% by weight to about 70% by weight and low-density polyethylene (LDPE) provided in a range of about 40% by weight to about 70% by weight.

The second core layer 40 can be a blend of linear low density polyethylene (LLDPE) provided in a range of about 25% by weight to about 65% by weight and low-density polyethylene (LDPE) provided in a range of about 35% by weight to about 75% by weight. The second core layer 40 can be a blend of linear low-density polyethylene (LLDPE) provided in a range of about 30% by weight to about 70% by weight and low-density polyethylene (LDPE) provided in a range of about 40% by weight to about 70% by weight.

The m-LLDPE is a metallocene linear low-density polyethylene material available from Dow Chemical Company, United States of America, under the brand name Elite 5230G or Elite 5230S. The metallocene linear low-density polyethylene (5230G) has a density of about 0.918 g/cm³, and a melt flow rate of about 4.0 g/10 min according to ASTM test methods D792 and D1238, respectively. The metallocene linear low-density polyethylene (5230S) has a density of about 0.916 g/cm³, and a melt flow rate of about 4.0 g/10 min according to ASTM test methods D792 and D1238, respectively.

The LLDPE is a linear low-density polyethylene material available from ExxonMobile, United States of America, under the brand name ExxonMobil LLDPE LL 3003 Series. The LLDPE has a density of about 0.918 g/cm³, and a melt index of about 3.2 g/10 min according to ASTM test methods D1505 and D1238, respectively.

TheLDPE is a low-density polyethylene material available from Dow Chemical Company, United States of America, under the brand name Agility 1021 Performance LDPE. The LDPE has a density of about 0.920 g/cm³, and a melt index of about 1.9 g/10 min according to ASTM test methods D1505 and D1238, respectively.

In one embodiment of the instant invention, a film 10 includes a first skin layer 20 comprising between about 5% and 20% by weight of the film, a second skin layer 50 comprising between about 5% and 20% by weight of the film, and a central layer comprising between about 60% and 90% by weight of the film.

In another embodiment of the instant invention, a film 10 includes a first skin layer 20 comprising between about 10% and 15% by weight of the film, a second skin layer 50 comprising between about 10% and 15% by weight of the film, a first core layer 30 comprising between about 35% and 40% by weight of the film, and a second core layer 40 comprising between about 35% and 40% by weight of the film.

In another embodiment of the instant invention, a film 10 includes a first skin layer 20 which is a slip layer comprising between about 80% and 95% of a linear low-density polyethylene, between about 4% and 20% of a high-density polyethylene, and between about 1% and 15% of an ionomer of ethylene acid copolymer/an ionomer of ethylene acid acrylate terpolymer, a second skin layer 50 which is a cling layer comprising between about 85% and 96% ultra-low-density polyethylene and between about 4% and 15% polyolefin-based thermoplastic elastomer, a first core layer 30 comprising a metallocene linear low-density polyethylene and a second core layer 40 comprising between about 30% and 60% metallocene linear low-density polyethylene and about 40% and 70% low-density polyethylene.

In yet another embodiment of the instant invention, a film includes a first skin layer 20 which is a slip layer comprising between about 80% and 95% of a linear low-density polyethylene, between about 4% and 20% of a high-density polyethylene, and between about 1% and 15% of an ionomer of ethylene acid copolymer/an ionomer of ethylene acid acrylate terpolymer, a second skin layer which is a cling layer comprising between about 85% and 96% ultra-low-density polyethylene and between about 4% and 15% polyolefin-based thermoplastic elastomer, a first core layer comprising a metallocene linear low-density polyethylene and a second core layer comprising between about 30% and 60% linear low density polyethylene and about 40% and 70% low-density polyethylene.

The instant invention also discloses a multilayer cling film 10 comprising a first skin layer 20 comprising a blend of a polyethylene and an ionomer, a second skin layer 50 comprising a blend of a polyethylene and a polyolefin-based thermoplastic elastomer, a first core layer 30 which is a metallocene linear low-density polyethylene (m-LLDPE) and a second core layer 40 which is a blend of linear low-density polyethylene (LLDPE) and low-density polyethylene (LDPE). The first skin layer 20 can be a slip layer comprising a LLDPE, a high-density polyethylene (HDPE) and an ionomer of ethylene acid copolymer/an ionomer of ethylene acid acrylate terpolymer. The second skin layer 50 can be a cling layer comprising an ultra-low-density polyethylene and a polyolefin-based thermoplastic elastomer (i.e., a propylene-based polyolefin polymer). Each skin layer 20, 50 comprises between about 5% by weight and about 20% by weight of the film 10, between about 7% by weight and about 12% by weight of the film 10, between about 10% by weight and about 15% by weight of the film 10, or between about 10% by weight and about 20% by weight of the film 10. Each core layer 30, 40 comprises between about 30% by weight and about 45% by weight of the film 10, between about 32% by weight and about 42% by weight of the film 10, between about 35% by weight and about 40% by weight of the film 10, or between about 30% by weight and about 40% by weight of the film 10.

The first skin layer 20 can be a slip layer comprising a polymer composition yielding a low coefficient of friction (COF) per the ASTM D1894. The COF of the first skin layer is at least less than 1.1, between about 0.1 and 1.1, between about 0.3 and 0.9, between about 0.5 and 0.9, between about 0.1 and 0.5, or between 0.6 and 0.9. The COF of the first skin layer is at least less than 1.1, 1.0, 0.9, 0.8, 0.7, 0.6, 0.5, or 0.4. The first skin layer 20 can be a slip layer comprising a linear low-density polyethylene (LLDPE), a high-density polyethylene (HDPE) and an ionomer of ethylene acid copolymer/an ionomer of ethylene acid acrylate terpolymer composition. The LLDPE is provided in a range of about 75% by weight to about 99% by weight, the HDPE is provided in a range of about 1% by weight to about 25% by weight and balance of the composition comprises the ionomer of ethylene acid copolymer/an ionomer of ethylene acid acrylate terpolymer. In one embodiment the LLDPE is provided in a range of about 80% by weight to about 95% by weight, the HDPE is provided in a range of about 4% by weight to about 20% by weight and the balance of the composition comprises the ionomer of ethylene acid copolymer/an ionomer of ethylene acid acrylate terpolymer, generally in a range of about 1% by weight to about 15% by weight. In another embodiment, the LLDPE is provided in a range of about 80% by weight to about 95% by weight, the HDPE is provided in a range of about 4% by weight to about 20% by weight and the ionomer of ethylene acid copolymer/an ionomer of ethylene acid acrylate terpolymer is provided in a range of about 1% by weight to about 15% by weight, and the balance of the composition comprises at least one resin or additive, such as stabilizers, UV absorbers, colorants, abrasion-resistant resins, and the like.

In one embodiment, the LLDPE is a linear low-density polyethylene plastic material commercially available from ExxonMobile, United States of America, under the brand name ExxonMobil LLDPE LL 1236 Series. The LLDPE has a density of about 0.925 g/cm3, and a melt index of about 3.6 g/10 min according to ASTM test methods D1505 and D1238, respectively.

The HDPE is a high-density plastic material commercially available from ExxonMobile, United States of America, under the brand name ExxonMobil HDPE 7845.30. The HDPE has a density of about 0.958 g/cm3, and a melt index of about 0.45 g/10 min and a high load melt index of about 28 g/10 min according to ASTM test methods D1505, D1238 and D1238, respectively.

The ionomer of ethylene acid copolymer/an ionomer of ethylene acid acrylate terpolymer is commercially available from Dupont-Dow, United States of America, under the brand name(s) Surlyn 1652, Surlyn 1605, and Surlyn 1901. The ionomer of ethylene acid copolymer (Surlyn 1652) has a density of 0.94 g/cm3, and a melt flow rate of 5.2 g/10 min according to ASTM test methods D792 and D1238, respectively. The ionomer of ethylene acid acrylate terpolymer (Surlyn 1605) has a density of 0.95 g/cm3, and a melt flow rate of 2.5 g/10 min according to ASTM test methods D792 and D1238, respectively. The ionomer of ethylene acid acrylate terpolymer (Surlyn 1901) has a density of 0.94 g/cm3, and a melt flow rate of 1.3 g/10 min according to ASTM test methods D792 and D1238, respectively. In yet another embodiment, a resin can be a substitute for the ionomer of ethylene acid copolymer/an ionomer of ethylene acid acrylate terpolymer. The resin is a PE LDPE with a higher density and melt flow rate. The substitute will have a density range of approximately 0.92-0.94 g/cm³ and a high melt flow rate range of approximately 3.0-6.5 g/10 min. The substitutes are commercially available from Dupont-Dow, United States of America, under the brand name(s) DOW 5004i LDPE (0.924 g/cm³, 4.2 g/10 min) and DOW 751A LDPE (0.925 g/cm³, 6.4 g/10 min).

The second skin layer 50 can be a cling layer comprising a polymer composition yielding a high cling. The force of the second skin layer 50 (cling layer) to the first skin layer 20 (slip layer), when wrapped around one or more items, is a least 20, generally at least about 30, preferably at least about 40 and more preferably about 50 N/mm2 as determined by the ASTM D5458-95 test. The second skin layer 50 can be a cling layer comprising an ultra-low-density polyethylene (ULDPE) and a polyolefin-based thermoplastic such as a propylene-based polyolefin polymer or a polypropylene-based elastomer with random ethylene distribution. The ULDPE is provided in a range of about 80% by weight to about 99% by weight, and the balance of the composition comprises a polyolefin-based thermoplastic. In one embodiment the ULDPE is provided in a range of about 82% by weight to about 97% by weight, and the balance of the composition comprises a polyolefin-based thermoplastic. In another embodiment the ULDPE is provided in a range of about 85% by weight to about 96% by weight, and the balance of the composition comprises a polyolefin-based thermoplastic. In another embodiment, the ULDPE is provided in a range of about 85% by weight to about 96% by weight, the polyolefin-based thermoplastic is provided in a range of about 4% by weight to about 15% by weight, and the balance of the composition comprises at least one resin or additive, such as stabilizers, UV absorbers, colorants, abrasion-resistant resins, and the like. The second skin layer 50 may further comprises additional resins and additives. In one embodiment, the second skin layer 50 comprises a puncture resistant resin. The optional cling additives may be present in the second skin layer 50 in a concentration of from about 0.5% by weight to about 10% by weight of the second skin layer 50 composition.

The ULDPE is an ultra-low-density polyethylene plastic material commercially available from Dow Chemical Company, United States of America, under the brand name ATTANE 4404G. The ULDPE has a density of about 0.906 g/cm3, and a melt flow rate of about 1.4 g/10 min according to ASTM test methods D792 and D1238, respectively.

The polyolefin-based thermoplastic is a as a propylene-based polyolefin polymer or a polypropylene-based elastomer with random ethylene distribution material from ExxonMobile, United States of America, under the brand name Vistamaxx Performance Polymer 6102. The propylene-based polyolefin polymer or a polypropylene-based elastomer with random ethylene distribution has a density of about 0.862 g/cm3, and a melt flow rate of about 3.0 g/10 min according to ASTM test methods D1505 and D1238, respectively. In another embodiment, a resin can be a substitute for the polyolefin-based thermoplastic. The resin is a polyolefin plastomer commercially available from Dupont-Dow, United States of America, under the brand name DOW Affinity KC 8852G (0.877 g/cm³, 3.0 g/10 min).

The first core layer 30 can be a linear low-density polyethylene provided at 100% by weight. The first core layer 30 can be a metallocene linear low-density polyethylene (m-LLDPE). In one embodiment, the m-LLDPE is a metallocene linear low-density polyethylene material available from Dow Chemical Company, United States of America, under the brand name Elite 5230G or Elite 5230S. The metallocene linear low-density polyethylene (5230G) has a density of about 0.918 g/cm³, and a melt flow rate of about 4.0 g/10 min according to ASTM test methods D792 and D1238, respectively. The metallocene linear low-density polyethylene (5230S) has a density of about 0.916 g/cm³, and a melt flow rate of about 4.0 g/10 min according to ASTM test methods D792 and D1238, respectively.

The second core layer 40 can be a blend of linear low density polyethylene (LLDPE) provided in a range of about 25% by weight to about 65% by weight and low-density polyethylene (LDPE) provided in a range of about 35% by weight to about 75% by weight. The second core layer 40 can be a blend of linear low-density polyethylene (LLDPE) provided in a range of about 30% by weight to about 70% by weight and low-density polyethylene (LDPE) provided in a range of about 40% by weight to about 70% by weight.

The LLDPE is a linear low-density polyethylene material available from ExxonMobile, United States of America, under the brand name ExxonMobil LLDPE LL 3003 Series. The LLDPE has a density of about 0.918 g/cm3, and a melt index of about 3.2 g/10 min according to ASTM test methods D1505 and D1238, respectively. The LDPE is a low-density polyethylene material available from Dow Chemical Company, United States of America, under the brand name Agility 1021 Performance LDPE. The LDPE has a density of about 0.920 g/cm3, and a melt index of about 1.9 g/10 min according to ASTM test methods D1505 and D1238, respectively.

In the above embodiments, the film 10 includes a first skin layer 20 comprising between about 5% and 20% by weight of the film, a second skin layer 50 comprising between about 5% and 20% by weight of the film, and a central layer comprising between about 60% and 90% by weight of the film.

In the above embodiments, the film 10 includes a first skin layer 20 comprising between about 10% and 15% by weight of the film, a second skin layer 50 comprising between about 10% and 15% by weight of the film, a first core layer 30 comprising between about 35% and 40% by weight of the film, and a second core layer 40 comprising between about 35% and 40% by weight of the film.

Alternative embodiments of the present invention provide a central layer 60 comprising at least two or more individual layers. It is understood that embodiments of the present invention may comprise as many individual layers in the central layer 60 as necessary or feasible to achieve desired material properties in a film 10. For example, at least one embodiment of the present invention provides a five-layer film having three core layers making up the central layer. Additional alternative embodiments provide for up to a fourteen-layer film, having twelve individual layers in the central layer 60. Additional embodiments provide for any number of layers contained within the range of the above-disclosed embodiments, as well as any number of layers feasible within the scope of the embodiments of the present invention.

Looking now to FIG. 2 there is illustrated another embodiment of the instant invention. FIG. 2 includes a film 10 comprising a first skin layer 20, a second skin layer 50, and a central layer 60 which includes a first core layer 30, a second core layer 40, a third core layer 70 and a fourth core layer 80. In one embodiment, the film illustrated in FIG. 2 includes a multilayer cling film comprising a first skin layer 20 comprising a blend of a polyethylene and an ionomer, a second skin layer 50 comprising a blend of a polyethylene and a polyolefin-based thermoplastic elastomer and one or more core layers comprising a polyethylene, a blend of two or more polyethylenes, or a combination thereof.

The first skin layer 20 and the second skin layer 50 may be comprised of any materials and at any of the weights and weight percentages previously mentioned. The first core layer 30, second core layer 40, third core layer 70 and fourth core layer 80 may be comprised of any materials and at any of the weights and weight percentages previously mentioned. Each skin layer 20, 50 comprises between about 5% by weight and about 20% by weight of the film 10, between about 7% by weight and about 12% by weight of the film 10, between about 10% by weight and about 15% by weight of the film 10, or between about 10% by weight and about 20% by weight of the film 10. Each core layer 30, 40, 70, 80 comprises between about 15% by weight and about 22% by weight of the film 10, between about 16% by weight and about 21% by weight of the film 10, between about 17% by weight and about 20% by weight of the film 10, or between about 15% by weight and about 20% by weight of the film 10.

In one embodiment of the instant invention, the skin layers 20, 50 may be located between one or more core layers 30, 40, 70, 80 while still retaining their slip and cling properties as previously described.

The instant invention also discloses a multilayer cling film 10 comprising a first skin layer 20 comprising a blend of a linear low-density polyethylene (LLDPE) and a resin, a second skin layer 50 comprising a blend of a linear low-density polyethylene and a polyolefin-based thermoplastic, or a blend of an ultra-low-density polyethylene and a polyolefin-based thermoplastic, a first core layer 30 which is a blend of a linear low-density polyethylene and a low-density polyethylene, a second core layer 40 which is a linear low-density polyethylene, or a blend of a linear low-density polyethylene and a low-density polyethylene, a third core layer which is a polypropylene random copolymer, or a blend of a linear low-density polyethylene and a low-density polyethylene, and a fourth core layer which is a polypropylene random copolymer, or a high-density polyethylene.

The first skin layer 20 can be a non-cling layer comprising a blend of an LLDPE or a metallocene linear low-density polyethylene (m-LLDPE) and a resin which is a PE LDPE. The second skin layer 50 can be a cling layer comprising a blend of an LLDPE and a polyolefin-based thermoplastic, or a metallocene linear low-density polyethylene (m-LLDPE) and a polyolefin-based thermoplastic. Each skin layer 20, 50 comprises between about 5% by weight and about 10% by weight of the film 10, between about 7% by weight and about 10% by weight of the film 10, about 7% by weight of the film 10, about 8% by weight of the film, about 9% by weight of the film, or about 10% by weight of the film 10. The first skin layer 20 can be a linear low-density polyethylene provided at 10% by weight plus a resin provided at 90% by weight. The first core layer 30 can be a metallocene linear low-density polyethylene (m-LLDPE). In one embodiment, the m-LLDPE is a metallocene linear low-density polyethylene material available from Dow Chemical Company, United States of America, under the brand name Elite 5230G or Elite 5230S. The metallocene linear low-density polyethylene (5230G) has a density of about 0.918 g/cm3, and a melt flow rate of about 4.0 g/10 min according to ASTM test methods D792 and D1238, respectively. The metallocene linear low-density polyethylene (5230S) has a density of about 0.916 g/cm3, and a melt flow rate of about 4.0 g/10 min according to ASTM test methods D792 and D1238, respectively. The first skin layer further includes a resin provided at 90% by weight. The resin is a PE LDPE with a higher density and melt flow rate. The substitute will have a density range of approximately 0.92-0.94 g/cm³ and a high melt flow rate range of approximately 3.0-6.5 g/10 min. The substitutes are commercially available from Dupont-Dow, United States of America, under the brand name(s) DOW 5004i LDPE (0.924 g/cm³, 4.2 g/10 min) and DOW 751A LDPE (0.925 g/cm³, 6.4 g/10 min).

The second skin layer 50 can be a cling layer comprising a polymer composition yielding a high cling. The force of the second skin layer 50 (cling layer) to the first skin layer 20 (slip layer), when wrapped around one or more items, is a least 20, generally at least about 30, preferably at least about 40 and more preferably about 50 N/mm2 as determined by the ASTM D5458-95 test. The second skin layer 50 can be a cling layer comprising a blend of a linear low-density polyethylene provided at 90% by weight and a polyolefin-based thermoplastic provided at 8%. The second skin layer 50 can be a cling layer comprising a blend of an LLDPE or a metallocene linear low-density polyethylene (m-LLDPE) and a polyolefin-based thermoplastic. In one embodiment, the m-LLDPE is a metallocene linear low-density polyethylene material available from Dow Chemical Company, United States of America, under the brand name Elite 5230G or Elite 5230S. The metallocene linear low-density polyethylene (5230G) has a density of about 0.918 g/cm3, and a melt flow rate of about 4.0 g/10 min according to ASTM test methods D792 and D1238, respectively. The metallocene linear low-density polyethylene (5230S) has a density of about 0.916 g/cm3, and a melt flow rate of about 4.0 g/10 min according to ASTM test methods D792 and D1238, respectively. The second skin layer also includes a polyolefin-based thermoplastic provided at 8% by weight, which is a propylene-based polyolefin polymer or a polypropylene-based elastomer with random ethylene distribution material from ExxonMobile, United States of America, under the brand name Vistamaxx Performance Polymer 6102. The propylene-based polyolefin polymer or a polypropylene-based elastomer with random ethylene distribution has a density of about 0.862 g/cm3, and a melt flow rate of about 3.0 g/10 min according to ASTM test methods D1505 and D1238, respectively. In another embodiment, a resin can be a substitute for the polyolefin-based thermoplastic. The resin is a polyolefin plastomer commercially available from Dupont-Dow, United States of America, under the brand name DOW Affinity KC 8852G (0.877 g/cm³, 3.0 g/10 min).

Alternatively, the second skin layer can be a blend of an ultra-low-density polyethylene (ULDPE) and a polyolefin-based thermoplastic such as a propylene-based polyolefin polymer or a polypropylene-based elastomer with random ethylene distribution. The ULDPE is a plastic material commercially available from Dow Chemical Company, United States of America, under the brand name ATTANE 4404G. The ULDPE has a density of about 0.906 g/cm3, and a melt flow rate of about 1.4 g/10 min according to ASTM test methods D792 and D1238, respectively. The second skin layer also includes a polyolefin-based thermoplastic provided at 6% by weight, which is a propylene-based polyolefin polymer or a polypropylene-based elastomer with random ethylene distribution material from ExxonMobile, United States of America, under the brand name Vistamaxx Performance Polymer 6102. The propylene-based polyolefin polymer or a polypropylene-based elastomer with random ethylene distribution has a density of about 0.862 g/cm3, and a melt flow rate of about 3.0 g/10 min according to ASTM test methods D1505 and D1238, respectively. In another embodiment, a resin can be a substitute for the polyolefin-based thermoplastic. The resin is a polyolefin plastomer commercially available from Dupont-Dow, United States of America, under the brand name DOW Affinity KC 8852G (0.877 g/cm³, 3.0 g/10 min). The ULDPE is provided in a range of about 90% by weight to about 99% by weight, 90% by weight, 91% by weight, 92% by weight, 93% by weight, 94% by weight, 95% by weight, 96% by weight, 97% by weight, 98% by weight, 99% by weight, and the balance of the composition comprises a polyolefin-based thermoplastic. In one embodiment the ULDPE is provided in a range of about 90% by weight to about 97% by weight, and the balance of the composition comprises a polyolefin-based thermoplastic. In another embodiment the ULDPE is provided in a range of about 90% by weight to about 94% by weight, and the balance of the composition comprises a polyolefin-based thermoplastic. In another embodiment, the ULDPE is provided at about 94% by weight, the polyolefin-based thermoplastic is provided in a range of about 6% by weight.

The first core layer 30 can be a linear low-density polyethylene provided at 50% by weight. The first core layer 30 can be a metallocene linear low-density polyethylene (m-LLDPE). In one embodiment, the m-LLDPE is a metallocene linear low-density polyethylene material available from Dow Chemical Company, United States of America, under the brand name Elite 5230G or Elite 5230S. The metallocene linear low-density polyethylene (5230G) has a density of about 0.918 g/cm3, and a melt flow rate of about 4.0 g/10 min according to ASTM test methods D792 and D1238, respectively. The metallocene linear low-density polyethylene (5230S) has a density of about 0.916 g/cm3, and a melt flow rate of about 4.0 g/10 min according to ASTM test methods D792 and D1238, respectively. The first core layer also includes a low-density polyethylene provided at 50% by weight. The LDPE is a low-density polyethylene material available from Dow Chemical Company, United States of America, under the brand name Agility 1021 Performance LDPE. The LDPE has a density of about 0.920 g/cm3, and a melt index of about 1.9 g/10 min according to ASTM test methods D1505 and D1238, respectively.

The second core layer 40 can be a linear low-density polyethylene provided at 100% by weight. The second core layer 40 can be a linear low-density polyethylene provided at 100% by weight can be a metallocene linear low-density polyethylene (m-LLDPE). In one embodiment, the m-LLDPE is a metallocene linear low-density polyethylene material available from Dow Chemical Company, United States of America, under the brand name Elite 5230G or Elite 5230S. The metallocene linear low-density polyethylene (5230G) has a density of about 0.918 g/cm3, and a melt flow rate of about 4.0 g/10 min according to ASTM test methods D792 and D1238, respectively. The metallocene linear low-density polyethylene (5230S) has a density of about 0.916 g/cm3, and a melt flow rate of about 4.0 g/10 min according to ASTM test methods D792 and D1238, respectively.

Alternatively, the second core layer 40 can be a linear low-density polyethylene provided at 50% by weight. The second core layer 40 can be a linear low-density polyethylene provided at 100% by weight can be a metallocene linear low-density polyethylene (m-LLDPE). In one embodiment, the m-LLDPE is a metallocene linear low-density polyethylene material available from Dow Chemical Company, United States of America, under the brand name Elite 5230G or Elite 5230S. The metallocene linear low-density polyethylene (5230G) has a density of about 0.918 g/cm3, and a melt flow rate of about 4.0 g/10 min according to ASTM test methods D792 and D1238, respectively. The metallocene linear low-density polyethylene (5230S) has a density of about 0.916 g/cm3, and a melt flow rate of about 4.0 g/10 min according to ASTM test methods D792 and D1238, respectively. The second core layer 40 also includes a low-density polyethylene provided at 50% by weight. The LDPE is a low-density polyethylene material available from Dow Chemical Company, United States of America, under the brand name Agility 1021 Performance LDPE. The LDPE has a density of about 0.920 g/cm3, and a melt index of about 1.9 g/10 min according to ASTM test methods D1505 and D1238, respectively.

The third core layer (a functional layer) 70 can be a polypropylene random copolymer provided at 100%. The polypropylene random copolymer is available from Braskem America, Inc., United States of America, under the brand name Braskem PP DR376-01. The polypropylene random copolymer has a density of about 0.900-0.920 g/cm3, and a melt index of about 7.0 g/10 min according to ASTM test method D1238

Alternatively, the third core layer 70 can be a linear low-density polyethylene provided at 50% by weight. The third core layer 70 can be a metallocene linear low-density polyethylene (m-LLDPE). In one embodiment, the m-LLDPE is a metallocene linear low-density polyethylene material available from Dow Chemical Company, United States of America, under the brand name Elite 5230G or Elite 5230S. The metallocene linear low-density polyethylene (5230G) has a density of about 0.918 g/cm3, and a melt flow rate of about 4.0 g/10 min according to ASTM test methods D792 and D1238, respectively. The metallocene linear low-density polyethylene (5230S) has a density of about 0.916 g/cm3, and a melt flow rate of about 4.0 g/10 min according to ASTM test methods D792 and D1238, respectively. The third core layer 70 also includes a low-density polyethylene provided at 50% by weight. The LDPE is a low-density polyethylene material available from Dow Chemical Company, United States of America, under the brand name Agility 1021 Performance LDPE. The LDPE has a density of about 0.920 g/cm3, and a melt index of about 1.9 g/10 min according to ASTM test methods D1505 and D1238, respectively.

The fourth core layer (a functional layer) 80 can be a polypropylene random copolymer provided at 100%. The polypropylene random copolymer is available from Braskem America, Inc., United States of America, under the brand name Braskem PP DR376-01. The polypropylene random copolymer has a density of about 0.900-0.920 g/cm3, and a melt index of about 7.0 g/10 min according to ASTM test method D1238.

Alternatively, the fourth core layer 80 can a high-density polyethylene (HDPE) provided at 100%. The HDPE is a high-density plastic material commercially available from ExxonMobile, United States of America, under the brand name ExxonMobil HDPE 7845.30. The HDPE has a density of about 0.958 g/cm3, and a melt index of about 0.45 g/10 min and a high load melt index of about 28 g/10 min according to ASTM test methods D1505, D1238 and D1238, respectively.

The above multilayer cling film can be as follows:
Ext A (20—first skin layer/non-cling layer—7-10%): Elite 5230 @ 10%+751A @ 90%
Ext B (30—first core layer 30-34%): Elite 5230 @ 50%+Agility 1021 @ 50%
Ext F (80—fourth core layer/functional layer—7-10%): PP DR376 @ 100% or HDPE @ 100%
Ext E (70—third core layer/functional layer—7-10%): PP DR376 @ 100% or (Elite 5230 @ 50%+Agility 1021 @ 50%)
Ext C (40—second core layer—30-34%): Elite 5230 @ 100% or (Elite 5230 @ 50%+Agility 1021 @ 50%)
Ext D (50—second skin layer/cling layer—7-10%): Elite 5230@ 90%+Vistamaxx (VM) 6102 @ 8% or (Attane 4404@94%+VM6102@6%)
   Agility LDPE 1021 substitute of, Dowlex LLDPE 2045/2045 G
   The main key resin to create a low COF is the Dow LDPE 751A/percentage range can be from (5-95%) in a layer
   The PP, HDPE and Agility/Dowlex combinations are as barrier grades to control the amount of COF on the release layer

The layers, concentrations, weight percentages, materials listed above may be incorporated and/or included within any of the embodiments described herein. Any method described herein may incorporate any design element contained within this application and any other document/application incorporated by reference herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present invention may be embodied in other forms without departing from the spirit and the essential attributes thereof, and, accordingly, reference should be made to the appended claims, rather than to the foregoing specification, as indicating the scope of the invention. The invention illustratively disclosed herein suitably may be practiced in the absence of any element which is not specifically disclosed herein.

1. A multilayer cling film comprising:
a first skin layer comprising a blend of a polyethylene and an ionomer;
a second skin layer comprising a blend of a polyethylene and a polyolefin-based thermoplastic elastomer; and
one or more core layers comprising a polyethylene, a blend of two or more polyethylenes, or a combination thereof.

2. The multilayer cling film of claim 1 wherein the first skin layer is a slip layer comprising a linear low-density polyethylene, a high-density polyethylene and an ionomer of ethylene acid copolymer/an ionomer of ethylene acid acrylate terpolymer.

3. The multilayer cling film of claim 1 wherein the second skin layer is a cling layer comprising an ultra-low-density polyethylene and a polyolefin-based thermoplastic elastomer.

4. The multilayer cling film of claim 1 wherein a first core layer is a linear low-density polyethylene and a second core layer is a blend of linear low-density polyethylene and low-density polyethylene.

5. The multilayer cling film of claim 4 wherein the first core layer is a metallocene linear low-density polyethylene and the second core layer is a blend of metallocene linear low-density polyethylene (m-LLDPE) and low-density polyethylene (LDPE).

6. The multilayer cling film of claim 1 wherein the polyolefin-based thermoplastic elastomer is a propylene-based polyolefin polymer.

7. The multilayer cling film of claim 1 wherein the first skin layer has a coefficient of friction between about 0.1 and 1.1.

8. The multilayer cling film of claim 1 wherein the second skin layer has a cling force has a cling force to the core layers of (0.3 Newtons=30 grams) or 30 N/mm².

9. The multilayer cling film of claim 1 wherein the first skin layer comprises between about 5% and 20% by weight of the film, the second skin layer comprises between about 5% and 20% by weight of the film, and the central layer comprises between about 60% and 90% by weight of the film.

10. The multilayer cling film of claim 1 wherein the first skin layer comprises between about 10% and 15% by weight of the film, the second skin layer comprises between about 10% and 15% by weight of the film, a first core layer comprises between about 35% and 40% by weight of the film, and a second core layer comprises between about 35% and 40% by weight of the film.

11. The multilayer cling film of claim 1 wherein:
the first skin layer is a slip layer comprising between about 80% and 95% of a linear low-density polyethylene, between about 4% and 20% of a high-density polyethylene, and between about 1% and 15% of an ionomer of ethylene acid copolymer/an ionomer of ethylene acid acrylate terpolymer;
the second skin layer is a cling layer comprising between about 85% and 96% ultra-low-density polyethylene and between about 4% and 15% polyolefin-based thermoplastic elastomer;
a first core layer comprising a metallocene linear low-density polyethylene; and
a second core layer comprising between about 30% and 60% metallocene linear low-density polyethylene and about 40% and 70% low-density polyethylene.

12. The multilayer cling film of claim 1 wherein:
the first skin layer is a slip layer comprising between about 80% and 95% of a linear low-density polyethylene, between about 4% and 20% of a high-density polyethylene, and between about 1% and 15% of an ionomer of ethylene acid copolymer/an ionomer of ethylene acid acrylate terpolymer;
the second skin layer is a cling layer comprising between about 85% and 96% ultra-low-density polyethylene and between about 4% and 15% polyolefin-based thermoplastic elastomer;
a first core layer comprising a metallocene linear low-density polyethylene; and
a second core layer comprising between about 30% and 60% linear low-density polyethylene and about 40% and 70% low-density polyethylene.

13. A multilayer cling film comprising:
a first skin layer comprising a blend of a polyethylene and an ionomer;
a second skin layer comprising a blend of a polyethylene and a polyolefin-based thermoplastic elastomer;
a first core layer is a metallocene linear low-density polyethylene; and
a second core layer is a blend of linear low-density polyethylene and low-density polyethylene.

14. The multilayer cling film of claim 13 wherein the first skin layer is a slip layer comprising a linear low-density polyethylene, a high-density polyethylene and an ionomer of ethylene acid copolymer/an ionomer of ethylene acid acrylate terpolymer.

15. The multilayer cling film of claim 13 wherein the second skin layer is a cling layer comprising an ultra-low-density polyethylene and a polyolefin-based thermoplastic elastomer.

16. The multilayer cling film of claim 13 wherein the polyolefin-based thermoplastic elastomer is a propylene-based polyolefin polymer.

17. The multilayer cling film of claim 13 wherein the first skin layer has a coefficient of friction between about 0.1 and 1.1.

18. The multilayer cling film of claim 13 wherein the second skin layer has a cling force has a cling force to the core layers of (0.3 Newtons=30 grams) or 30 N/mm².

19. The multilayer cling film of claim 13 wherein the first skin layer comprises between about 5% and 20% by weight of the film, the second skin layer comprises between about 5% and 20% by weight of the film, and the core layer comprises between about 60% and 90% by weight of the film.

20. The multilayer cling film of claim 13 wherein the first skin layer comprises between about 10% and 15% by weight of the film, the second skin layer comprises between about 10% and 15% by weight of the film, a first core layer comprises between about 35% and 40% by weight of the film, and a second core layer comprises between about 35% and 40% by weight of the film.
